(19) United States
(12) Patent Application Publication
(10) Pub. No.: US 2026/0252263 A1
(43) Pub. Date: Aug. 27, 2026

(54) APPARATUS WITH ADAPTIVE OPERATION CONTROL MECHANISM AND METHODS FOR OPERATING THE SAME

(71) Applicant: Micron Technology, Inc., Boise, ID (US)

(72) Inventors: Kecheng Liu, Shanghai (CN); Jing Ping Lu, Shanghai (CN); Bingsheng Liu, Shanghai (CN); Yunhong Wang, Shanghai (CN)

(21) Appl. No.: 19/532,869

(22) Filed: Feb. 6, 2026

Related U.S. Application Data
(60) Provisional application No. 63/761,812, filed on Feb. 21, 2025.

(51) Int. Cl. G06F 3/06

(52) U.S. Cl. CPC G06F 3/0655; G06F 3/0604; G06F 3/0679

(57) ABSTRACT

Disclosed herein are methods, apparatuses and systems related to adjusting memory operations according to real-time parameters. The apparatus may manage erase operations separately from read and write operations.

### CROSS-REFERENCE TO RELATED APPLICATION(S)

The present application claims priority to U.S. Provisional Patent Application No. 63/761,812, filed February 21, 2025, the disclosure of which is incorporated herein by reference in its entirety.

### TECHNICAL FIELD

The disclosed embodiments relate to devices, and, in particular, to semiconductor memory devices with adaptive operation control mechanism and methods for operating the same.

### BACKGROUND

Memory systems can employ memory devices to store and access information. The memory devices can include volatile memory devices, non-volatile memory devices (e.g., flash memory employing “NAND” technology or logic gates, “NOR” technology or logic gates, or a combination thereof), or a combination device. The memory devices utilize electrical energy, along with corresponding threshold levels or processing/reading voltage levels, to store and access data. However, the performance or characteristics of the memory devices can be affected by usage and demand.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIG. 1 is a block diagram of a computing system in accordance with an embodiment of the present technology.

FIG. 2 is a flow diagram illustrating a first example method of operating an apparatus in accordance with an embodiment of the present technology.

FIG. 3 is a schematic view of a system that includes an apparatus in accordance with an embodiment of the present technology.

### DETAILED DESCRIPTION

As described in greater detail below, the technology disclosed herein relates to an apparatus, such as memory systems, systems with memory devices, related methods, etc., for dynamically controlling operations according to real-time parameters. For example, a memory system can dynamically control a number of erase operations according to real-time power consumption/budget, current temperature, operating modes, and/or other real-time conditions of the memory system.

For context, a memory system typically operates according to requirements. For example, datacenter solid state drives (SSDs) are often required to operate according to preset power and thermal requirements. Such requirements often limit the number of parallel operations (e.g., NAND or back end (BE) operations) given the positive correlation between the requirements and the count of in-flight commands, such as erase, write, and read commands.

To fulfill such operating requirements, some devices utilize total available credits to control or limit the number of parallel operations. For example, a controller within the memory system can assign a predetermined credit value corresponding to each memory operation. Before the received command is executed by the BE, the controller can apply the credit first from the total credit pool. When credit is available and applied, the controller logic can pass the command and implement the corresponding operation at the BE/NAND. Once the BE completes the commanded operation, the BE can provide a status report, and the controller logic can free the credit to return back to the credit pool. Otherwise, when credit is unavailable (e.g., indication that a maximum number of parallel operations are already in progress), the controller logic can hold or pause the command from being passed on to the BE until sufficient credit is freed up and becomes available in the credit pool.

Such credit-based control mechanism may introduce inefficiencies when the memory system is operating in certain states, such as low power state and heavy thermal throttling state, where the total credit would be too small to keep enough NAND operation parallelism. The reduced amount of total credits can cause insufficient amount of credits to finish erase operations, thus preventing release of block stripe by erase. Preventing or reducing the release or freeing of block stripe can prevent or reduce the free block stripe necessary for implementing new writes, thereby causing the memory system to enter an error state.

To address the cause for such error states, embodiments of the technology described herein can include an adaptive operation control mechanism that dynamically controls the implemented operations according to real-time parameters. In some embodiments, the adaptive operation control mechanism can be implemented in firmware (e.g., hardware logic, software, or a combination thereof) to specifically target one or more types of operations, such as erase operations. The adaptive operation control mechanism can control the targeted types of operations independent of the credit-based system. For example, the adaptive operation control mechanism can control the implementations of the erase operations in firmware, while a different logic, process, software, or a combination thereof maintains the credit-based control mechanism for writes and reads.

The adaptive operation control mechanism can control the targeted operations according to real-time conditions, such as operating states, current power consumption, current temperature of the memory system, and/or the like. Effectively, the adaptive operation control mechanism can use the real-time conditions to predict or estimate the number of other types of operations. Continuing with the illustrative example above, the adaptive operation control mechanism can use the real-time parameters to estimate the number of reads and/or writes that is likely to be implemented through the credit-based system in an upcoming period of time. Based on the real-time parameters and/or the corresponding estimate, the adaptive operation control mechanism can generate a set of the targeted commands (e.g., erase commands) to be implemented by the BE. Stated differently, the adaptive operation control mechanism can control the number of implementations for the targeted type of operations according to the real-time conditions of the memory system and the corresponding estimate of parallel operations.

Accordingly, the adaptive operation control mechanism can provide increased efficiency and balance in managing the number and types of parallel operations within the memory system. For example, the adaptive operation control mechanism can identify opportune conditions to maximize the erase operations and reduce/prevent the above-mentioned error conditions. Moreover, the adaptive operation control mechanism can be implemented in firmware and independent of other hardware (e.g., logic controlling the credits), thereby providing ease and simplicity in implementing the described technology. Details regarding the adaptive operation control mechanism is described below.

### Example Environment

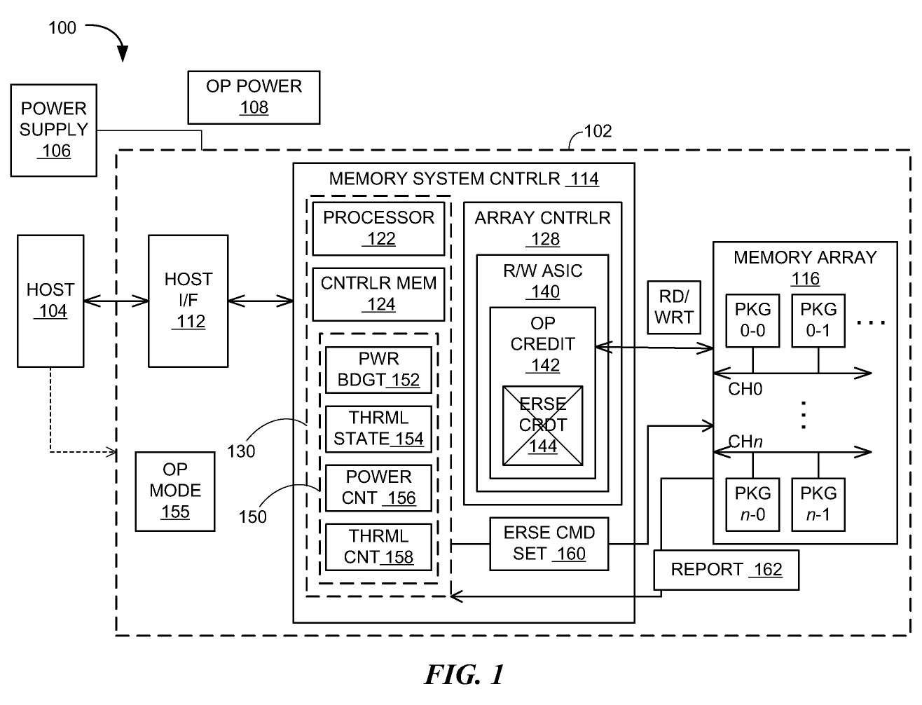

FIG. 1 is a block diagram of a computing system 100 in accordance with an embodiment of the present technology. The computing system 100 can include a personal computing device/system, an enterprise system, a mobile device, a server system, a database system, a distributed computing system, or the like.

The computing system 100 can have a memory system 102 coupled to a host device 104. The host device 104 can include one or more system processors that can write data to and/or read data from the memory system 102. For example, the host device 104 can include an upstream central processing unit (CPU). The memory system 102 and/or the host device 104 can be powered by a power supply 106.

The memory system 102 can include circuitry configured to store data (via, e.g., write operations) and provide access to the stored data (via, e.g., read operations). For example, the memory system 102 can include a persistent or non-volatile data storage system, such as a NAND-based Flash drive system, an SSD system, an SD card, or the like. In addition to writing and reading, the memory system 102 can erase the previously stored data. The erase operation may be used to remove data, such as in response to an erase command from the host 104, and/or as a part of moving the stored data to a different storage location (e.g., in combining data from partially written blocks into one block or in rewriting the data to a new data block to refresh).

During operation, the memory system 102 can consume varying amounts of operating power 108. For example, the memory system 102 can consumer a larger amount of the operating power 108 with increasing number of parallel operations.

The memory system 102 can include a host interface 112 (e.g., buffers, transmitters, receivers, and/or the like) configured to facilitate communications with the host device 104. The host interface 112 can be configured to support one or more host interconnect schemes, such as Universal Serial Bus (USB), Peripheral Component Interconnect (PCI), Serial AT Attachment (SATA), or the like. The host interface 112 can receive commands, addresses, data (e.g., write data), and/or other information from the host device 104. The host interface 112 can also send data (e.g., read data) and/or other information to the host device 104. In some embodiments, the host interface 112 can be configured to implement the UFS protocols in communicating with the host device 104.

The memory system 102 can further include a memory system controller 114 (also called a micro controller) and a memory array 116 (also called the BE). The memory array 116 can include memory cells that are configured to store a unit of information. The memory system controller 114 can be configured to control the overall operation of the memory system 102, including the operations of the memory array 116.

In some embodiments, the memory array 116 can include a set of persistent memory (e.g., NAND) devices, packages, dies, or the like. Each of the packages can include a set of memory cells that each store data in a charge storage structure. The memory cells can include, for example, floating gate, charge trap, phase change, ferroelectric, magnetoresitive, and/or other suitable storage elements configured to store data persistently or semi-persistently. The memory cells can be one-transistor memory cells that can be programmed to a target state to represent information. For instance, electric charge can be placed on, or removed from, the charge storage structure (e.g., the charge trap or the floating gate) of the memory cell to program the cell to a particular data state. The stored charge on the charge storage structure of the memory cell can indicate the Vt of the cell. For example, a single level cell (SLC) can be programmed to a targeted one of two different data states, which can be represented by the binary units 1 or 0. Also, some flash memory cells can be programmed to a targeted one of more than two data states. Multilevel cells (MLCs) may be programmed to any one of four data states (e.g., represented by the binary 00, 01, 10, 11) to store two bits of data. Similarly, triple level cells (TLCs) may be programmed to one of eight (i.e., 2³) data states to store three bits of data, and quad level cells (QLCs) may be programmed to one of 16 (i.e., 2⁴) data states to store four bits of data.

Such memory cells may be arranged in rows (e.g., each corresponding to a word line 143) and columns (e.g., each corresponding to a bit line). The arrangements can further correspond to different groupings for the memory cells. For example, each word line can correspond to one or more memory pages. Also, the memory array 116 can include memory blocks that each include a set of memory pages. In operation, the data can be written or otherwise programmed (e.g., erased) with regards to the various memory regions of the memory array 116, such as by writing to groups of pages and/or memory blocks. In NAND-based memory, a write operation often includes programming the memory cells in selected memory pages with specific data values (e.g., a string of data bits having a value of either logic 0 or logic 1). An erase operation is similar to a write operation, except that the erase operation re-programs an entire memory block or multiple memory blocks to the same data state (e.g., logic 0).

As described above, the memory system controller 114 can be configured to control the operations of the memory array 116. The memory system controller 114 can include a processor 122, such as a special purpose logic circuitry (e.g., a field programmable gate array (FPGA), an application specific integrated circuit (ASIC), etc.), a microprocessor, or other suitable processor. The processor 122 can execute instructions encoded in hardware, firmware, and/or software (e.g., instructions stored in controller embedded memory 124) to execute various processes, logic flows, and routines for controlling operation of the memory system 102 and/or the memory array 116.

Further, the memory system controller 114 can further include an array controller 128 that controls or oversees detailed or targeted aspects of operating the memory array 116. For example, the array controller 128 can provide a communication interface between the processor 122 and the memory array 116 (e.g., the components therein). The array controller 128 can function as a multiplexer/demultiplexer, such as for handling transport of data along serial connection to flash devices in the memory array 116.

In some embodiments, the memory system controller 114 can include predetermined firmware 130, such as a portion of permanent software programmed into read-only memory in the controller embedded memory 124. The firmware 130 can be used to implement the adaptive operation control mechanism separate from the credit-based operation management mechanism. The adaptive operation control mechanism can control one or more types of targeted memory operations, and the credit-based management mechanism can control one or more remaining types of memory operations.

As an illustrative example, the credit-based operation management system can be implemented using a read-write (RW) logic (e.g., ASIC) 140 in the array controller 128. The RW logic 140 can track an operation credit pool 142 corresponding to a total maximum number of available parallel operations. Unlike conventional devices, the RW logic 140 for embodiments of the technology can track and control implementations of the read and write operations. In other words, unlike the conventional devices that track erase operations together with reads and writes, the RW logic 140 can operate independent of and without accounting for the erase operations (e.g., without utilizing erase credits 144). Accordingly, when read or write operations are received, the RW logic 140 can assign corresponding amounts of credits from the operation credit pool 142.

When sufficient amount of credit is available in the credit pool 142, the RW logic 140 can send a command to the memory array 116 to implement the received read or write command. When the memory array 116 finishes implementing the received read or write command, the memory array 116 can send an acknowledgement or a report to the RW logic 140, and the RW logic 140 can release the credits previously assigned to the now completed operation back into the credit pool 142. When the credit pool 142 has insufficient amount of credits (e.g., indicating that the maximum number of parallel operations are already being implemented), the RW logic 140 can wait until one or more of the ongoing operations are completed and sufficient amount of credits become available within the credit pool 142.

Continuing with the illustrative example, the controller 114 can manage the erase operations using the adaptive operation control mechanism that is implemented outside of the RW logic 140. In some embodiments, the controller firmware 130 can include a portion (e.g., a segment of software, code, and/or a corresponding hardware circuit) configured to implement a dynamic erase manager 150. The dynamic erase manager 150 can control a number of erase operations implemented at the memory array 116 for a given time period and/or in parallel to the read and write operations managed by the RW logic 140.

The dynamic erase manager 150 can control the number of implemented operations according to real-time parameters that indicate a current state of the memory system 102. Some examples of the real-time parameters can include a current power budget 152, a current thermal state 154, a targeted operating mode 155, and/or the like.

The current power budget 152 can indicate a remaining amount of expendable power. For example, the dynamic erase manager 150 can compute the current power budget 152 as a difference between a predetermined maximum consumable power and the current operating power 108.

The current thermal state 154 can correspond to a current temperature of the memory system 102 (e.g., a value obtainable from an internal sensor). In some embodiments, the current thermal state 154 can indicate a normal operating state when the current operating temperature is within a predetermined operating range or a thermal throttling state when the current operating temperature exceeding the predetermined operating range. The thermal throttling state can cause the memory system 102 to limit or reduce its functionalities, such as by reducing the maximum number of parallel operations, to lower the operating temperature and to better preserve the stored data.

The targeted operating mode 155 can represent one or more operating modes correlated to specific goals and/or conditions associated with balancing erase operations, predicting read and write patterns, or a combination thereof. The targeted operating mode 155 can be provided by the host 104 or self-identified by the memory device 102. In some embodiments, the targeted operating mode 155 can include operating modes that require clearing or availing of a set of memory blocks or block stripe within a given amount of time. Some examples of the targeted operating mode 155 can include a period following a power on/reset event, a Low-Level Format (LLF) state, an NVMe command (e.g., security erase), a predictable read/write pattern (e.g., steady state or idle pattern), and/or the like.

The dynamic erase manager 150 can use one or more of the real-time input parameters to dynamically compute the number of erase commands. In some embodiments, the dynamic erase manager 150 can compute a power count 156 based on power-based parameters (e.g., the power budget 152, the targeted operating mode 155, or a combination thereof) and a thermal count 158 based on temperature-based parameters (e.g., the thermal state 154). The dynamic erase manager 150 can compute the number of erase commands based on the power count 156 and the thermal count 158. According to the computed number, the dynamic erase manager 150 can generate an erase command set 160. The generated erase command set 160 (e.g., a set having the computed number of erase commands for corresponding locations) can be provided to the memory array 116. The memory array

116 can implement the erase operations according to the erase command set 160 and then, upon completion, provide one or more reports 162 back to the dynamic erase manager 150.

### Control Flow

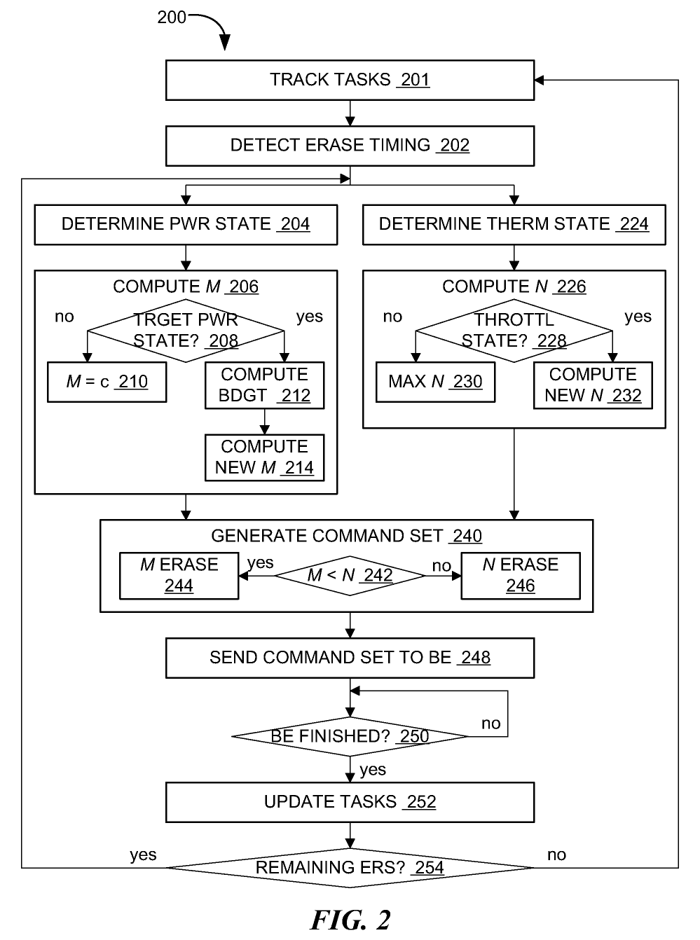

FIG. 2 is a flow diagram illustrating an example method 200 of operating an apparatus (e.g., the memory system 102 of FIG. 1 or one or more components therein) in accordance with an embodiment of the present technology. The example method 200 can be for implementing the dynamic erase manager 150 of FIG. 1 to manage the erase operations. The example method 200 can be implemented using the controller firmware 130 of FIG. 1 and in parallel with or independent of the credit-based control management (e.g., the RW logic 140 of FIG. 1) that manages the read and write operations.

At block 201, the memory system 102 can track tasks. The memory system controller 114 of FIG. 1 can track the implemented operations and/or necessary housekeeping/maintenance operations. Accordingly, at block 202, the memory system 102 can detect a timing for the targeted operation, such as for an erase timing. For example, the memory system controller 114 detect that one or more erase operations are necessary, identify an upcoming timing for and/or a window that correspond to or avail implementation of the erase operations. In some embodiments, the memory system controller 114 can detect the erase timing based on identifying the mode control 155 of FIG. 1 (e.g., the LLF mode) or receiving a corresponding command from the host 104 of FIG. 1.

In response to detecting the timing/need of the targeted operation, the memory system 102 can determine one or more real-time current condition of the memory system 102 and then control implementation of the targeted operation. For example, the dynamic erase manager 150 can obtain the parameters that represent the real-time current conditions and then compute an appropriate number of erase operations. The dynamic erase manager 150 can use the obtained parameters to detect or estimate scenarios or conditions that require a set number of erase operations within a preset duration and/or predict or estimate upcoming read/write patterns. Moreover, the dynamic erase manager 150 can use the obtained parameters to compute a number of erase operations that would increase the operational efficiency for the current real-time conditions.

In obtaining the parameters, the dynamic erase manager 150 can determine a power state of the memory system 102, as shown in block 204. The dynamic erase manager 150 can determine the power state based on the current control mode 155.

At block 206, the dynamic erase manager 150 can compute the power count 156 of FIG. 1 (shown as M). The dynamic erase manager 150 can compute the power count 156 based on the determined power state. For example, as shown at decision block 208, the dynamic erase manager 150 can determine whether the power state matches one or more predetermined target states, such as LLF, NVMe commands (e.g., security erase), steady or idle state workload, and/or the like. In some embodiments, the predetermined targeted states can represent relatively lower (e.g., according to a predetermined threshold) power consumption states, a likely number of expected reads/writes that is less than a threshold, and/or the like. When the power state is outside of the predetermined target states, as shown at block 210, the dynamic erase manager 150 can set the power count 156 to a predetermined number (shown as c), such as a minimum quantity of erase operations (e.g., one erase operation per iteration/window).

When the current power state matches one or more predetermined target states, as shown at block 212, the dynamic erase manager 150 can compute the current power budget 152 of FIG. 1. For example, the dynamic erase manager 150 can calculate a difference between a predetermined maximum consumable power and the current operating power 108. At block 214, the dynamic erase manager 150 can dynamically compute the new value of the power count 156 according to the current power budget 152. In dynamically computing the power count 156, the dynamic erase manager 150 can use the current power budget 152 as an input for a predetermined lookup table, a predetermined equation/process, and/or the like.

In parallel with the power-based computations (e.g., blocks 204 – 214) and/or when the current power state matches one or more predetermined target states, the dynamic erase manager 150 can analyze the thermal aspects of the memory system 102 for implementing increased number of erase operations. At block 224, the dynamic erase manager 150 can determine a thermal state of the memory system 102. In some embodiments, the dynamic erase manager 150 can obtain a reading from an onboard sensor, and then compare the sensor reading to one or more thresholds to determine the thermal state. In other embodiments, the dynamic erase manager 150 can assess the current mode control 155 to determine the thermal state.

At block 226, the dynamic erase manager 150 can compute the thermal count 158 (shown as N) according to the determined thermal state. For example, as shown in decision block 228, the dynamic erase manager 150 can determine whether the memory system 102 is in a thermal throttling state (e.g., one or more predetermined state associated with the current operating temperature exceeding a predetermined threshold). When the memory system 102 is not in a thermal throttling state, the dynamic erase manager 150 can set the thermal count 158 to a predetermined maximum number of erase operations (e.g., 10, 15, 20, 30, 50, or more).

When the memory system 102 is in a thermal throttling state, the dynamic erase manager 150 can dynamically compute the new value of the thermal count 158 based on the thermal state 154, the current mode control 155, or a combination thereof. For example, the dynamic erase manager 150 can use the current temperature as an input for a predetermined lookup table, a predetermined equation/process, and/or the like to compute the thermal count 158.

At block 240, the dynamic erase manager 150 can generate a command set according to the power count 156 and the thermal count 158. For example, at decision block 242, the dynamic erase manager 150 can determine whether the power count 156 is less than the thermal count 158. If so, the dynamic erase manager 150 can generate the erase command set 160 having a number of erase commands corresponding to the power count 156 as shown in block 244. Otherwise, if the power count 156 is not greater than the thermal count 158, the dynamic erase manager 150 can generate the erase command set 160 having a number of erase commands corresponding to the thermal count 158 as shown in block 246. Alternatively, the erase manager 150 can generate the erase command set 160 having a number of erase commands corresponding to a greater of the counts or a mathematical combination of the counts (e.g., an average value). At block 248, the dynamic erase manager 150 can send the generated erase command set 160 to the BE for implementation.

In other embodiments, the dynamic erase manager 150 can use a linear/sequential process that first examines the power state and then the thermal state. For example, the dynamic erase manager 150 can first determine the power state and default to the minimum erase count when the memory device is not operating in the targeted power state. Accordingly, the dynamic erase manager 150 can prioritize the power consideration over the thermal consideration. When the memory system 102 is operating in the targeted power state, the dynamic erase manager 150 can dynamically compute the power count 156 and the thermal count 158. As described above, the dynamic erase manager 150 can compute the thermal count 158 according to whether or not the memory system 102 has entered the thermal throttling state and the current temperature. After computing the power count 156 and the thermal count 158, the dynamic erase manager 150 can generate and send the command set as described above.

Regardless of the parallel processing or sequential processing, the dynamic erase manager 150 can detect the real-time conditions that allow for multiple erases based on the real-time power consumption and the current temperature of the memory device. Moreover, the dynamic erase manager 150 can dynamically compute the number of erase operations that match or is appropriate for the real-time power consumption and the current temperature. Since the controller firmware 130 implements the dynamic erase manager 150, the credit-based operation management can operate independent of the dynamic erase manager 150 and without impacting the operation credit pool 142. For example, the operation credit pool 142 can remain the same as that of the conventional systems that handle the erase operations, together with the read and write operations, at the same logic.

At decision block 250, the dynamic erase manager 150 can effectively wait until the BE finishes implementing the erase command set 160. When the dynamic erase manager 150 receives the corresponding status report 162 indicating completion of the erase command set 160, the memory system 102 can update the tasks as shown in block 252. At decision block 254, the memory system 102 can determine whether the tracked tasks further include other/remaining erase operations. If so, the memory system 102 can re-determine the power and thermal states and compute the appropriate number of erase operations as shown by the feedback loop to blocks 204 and 224. Otherwise, having performed the necessary erase operations, the memory system 102 can return to tracking the tasks as shown by the feedback loop to block 201.

### Overall System

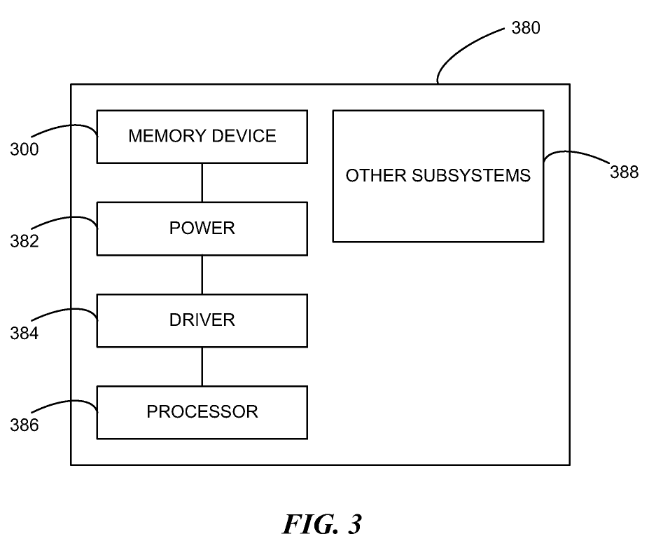

FIG. 3 is a schematic view of a system that includes an apparatus in accordance with embodiments of the present technology. Any one of the foregoing apparatuses (e.g., memory systems) described above with reference to FIGS. 1-2 can be incorporated into any of a myriad of larger and/or more complex systems, a representative example of which is system 380 shown schematically in FIG. 3. The system 380 can include a memory device 300, a power source 382, a driver 384, a processor 386, and/or other subsystems or components 388. The memory device 300 can include features generally similar to those of the apparatus described above with reference to one or more of the FIGS. 1-2, and can therefore include various features for performing a direct read request from a host device. The resulting system 380 can perform any of a wide variety of functions, such as memory storage, data processing, and/or other suitable functions. Accordingly, representative systems 380 can include, without limitation, hand-held devices (e.g., mobile phones, tablets, digital readers, and digital audio players), computers, vehicles, appliances and other products. Components of the system 380 may be housed in a single unit or distributed over multiple, interconnected units (e.g., through a communications network). The components of the system 380 can also include remote devices and any of a wide variety of computer readable media.

From the foregoing, it will be appreciated that specific embodiments of the technology have been described herein for purposes of illustration, but that various modifications may be made without deviating from the disclosure. In addition, certain aspects of the new technology described in the context of particular embodiments may also be combined or eliminated in other embodiments. Moreover, although advantages associated with certain embodiments of the new technology have been described in the context of those embodiments, other embodiments may also exhibit such advantages and not all embodiments need necessarily exhibit such advantages to fall within the scope of the technology. Accordingly, the disclosure and associated technology can encompass other embodiments not expressly shown or described herein.

In the illustrated embodiments above, the apparatuses have been described in the context of NAND Flash devices. Apparatuses configured in accordance with other embodiments of the present technology, however, can include other types of suitable storage media in addition to or in lieu of NAND Flash devices, such as, devices incorporating NOR-based non-volatile storage media (e.g., NAND flash), magnetic storage media, phase-change storage media, ferroelectric storage media, dynamic random access memory (DRAM) devices, etc.

The term "processing" as used herein includes manipulating signals and data, such as writing or programming, reading, erasing, refreshing, adjusting or changing values, calculating results, executing instructions, assembling, transferring, and/or manipulating data structures. The term data structure includes information arranged as bits, words or code-words, blocks, files, input data, system-generated data, such as calculated or generated data, and program data. Further, the term "dynamic" as used herein describes processes, functions, actions or implementation occurring during operation, usage, or deployment of a corresponding device, system or embodiment, and after or while running manufacturer's or third-party firmware. The dynamically occurring processes, functions, actions or implementations can occur after or subsequent to design, manufacture, and initial testing, setup or configuration.

The above embodiments are described in sufficient detail to enable those skilled in the art to make and use the embodiments. A person skilled in the relevant art, however, will understand that the technology may have additional embodiments and that the technology may be practiced without several of the details of the embodiments described above with reference to one or more of the FIGS. 1-3 described above.

I/We claim:

1. A memory system, comprising:
a set of non-volatile (NV) memory cells configured to store data through write operations and to recall the stored data through read operations;
a read-write logic coupled to the set of NV memory cells;
a controller coupled to the set of NV memory cells, the controller including:
a logic circuit; and
a local memory coupled to the logic circuit and including read-only instructions corresponding to firmware for the controller, wherein the firmware is configured to:
compute an erase count according to one or more real-time parameters; and
implement a number of erase operations at the set of NV memory cells according to the erase count.

2. The memory system of claim 1, wherein the firmware is configured to:
obtain the one or more real-time parameters representative of a targeted power-based state including a Low-Level Format (LLF) mode, a NV Memory Express (NVMe) command for a security erase, and/or a period associated with a period following a power reset condition.

3. The memory system of claim 2, wherein the erase count is computed according to a maximum consumable power for the power-based states, wherein the erase count is two or more.

4. The memory system of claim 3, wherein the computing the erase count includes analyzing one or more thermal states after or in parallel with assessing the power-based states for adjusting the erase count.

5. The memory system of claim 4, wherein the erase count is computed based on:
computing a power count according to the one or more power-based states;
computing a thermal count according to the one or more thermal states; and
selecting a lesser of the power count and the thermal count for the erase count.

6. The memory system of claim 5, wherein the one or more thermal states includes a thermal throttling state.

7. The memory system of claim 5, wherein the firmware is configured to:
obtain a current operating temperature of the memory device or a portion thereof;
based on assessing the power-based states, determine that the memory device is operating in a thermal throttling mode; and
compute the thermal count according to the current temperature and determining that the memory device is operating in the thermal throttling mode.

8. The memory system of claim 5, wherein the firmware is configured to:
based on assessing the power-based states, determine that the memory device is not operating in a thermal throttling mode; and
compute the thermal count according to a default count when the memory device is not operating in the thermal throttling mode, wherein the default count is greater than 10.

9. The memory system of claim 2, wherein the erase count is computed according to a default count of one when the memory device is operating outside of the targeted power-based state.

10. The memory system of claim 1, wherein the read-write logic is configured to control a number of read operations and write operations that are simultaneously implemented at the set of non-volatile memory cells, wherein the firmware computes the erase count and implements the number of erase operations independent of the control of the number of read operations and write operations at the read-write logic.

11. A method of operating a memory device, the method comprising:
maintaining a credit pool for controlling a number of read operations and write operations that are simultaneously implemented at a set of non-volatile (NV) memory cells;
independent of the credit pool, computing an erase count according to one or more real-time parameters; and
implementing a number of erase operations at the set of NV memory cells according to the erase count.

12. The method of claim 11, wherein computing the erase count and implementing the number of erase operations are implemented using firmware.

13. The method of claim 12, wherein maintenance of the credit pool is implemented by a read-write logic separate from the firmware.

14. The method of claim 11, further comprising:
determining that the memory device is operating in a targeted power-based state that includes at least one of a Low-Level Format (LLF) mode, a NV Memory Express (NVMe) command for a security erase, and a period associated with a period following a power reset condition, wherein the erase count is computed as a number greater than one based on the determination that the memory device is operating in the targeted power-based state.

15. The method of claim 14, further comprising:
determining that the memory device is operating in a thermal throttling state;
computing a power count according to a current operating power; and
computing a thermal count according to a current temperature;
wherein:
the erase count is computed based on selecting a lesser of the power count and the thermal count.

16. The method of claim 14, further comprising:
determining that the memory device is operating outside of a thermal throttling state;
computing a power count according to a current operating power; and
computing a thermal count according to a default count, wherein the default count is greater than 10;
wherein:
the erase count is computed based on selecting a lesser of the power count and the thermal count.

17. A memory device, comprising:
memory cells configured to store data through write operations and to recall the stored data through read operations; and
a controller coupled to the memory cells, the controller configured to:
compute an erase count according to one or more real-time parameters; and
manage implementation of one or more erase operations according to the erase count within a given interval, wherein the one or more erase operations are managed using a circuit that is separate from a circuit controlling the read and write operations.

18. The memory device of claim 17, wherein the controller includes:
a read-write logic coupled to the set of NV memory cells and configured to manage the read and write operations; and
a processor configured to implement a firmware that manages the one or more erase operations.

19. The memory device of claim 17, wherein the controller is further configured to:
compute the erase count to a predetermined minimum when the memory device is operating outside of one or more targeted power states.

20. The memory device of claim 17, wherein the controller is further configured to:
determine that the memory device operating in one or more targeted power states;
based on the determination, calculate a power count according to a current operating power;
based on the determination, calculate a thermal count according to a current temperature of the memory device; and
compute the erase count based on balancing or combining the power count and the thermal count.
